(19) United States
(12) Patent Application Publication
(10) Pub. No.: US 2001/0024601 A1
(43) Pub. Date: Sep. 27, 2001

(54) Method and device for hand-operated machine tools for optimized cutting of different substrates by energy adaptation

(76) Inventors: Stefan Miescher, Eschen (LI); Fritz Mark, Mader (AT); Bernard Favre Bulle, Feldkirch-Tosters (AT); Thomas Hofbrucker, Mammendorf (DE); Steffen Dohm, St. Gallen (SZ)

Correspondence Address: David Toren, BROWN & WOOD LLP, One World Trade Center, New York, NY, 10048-0557, US

(21) Appl. No.: 09/814,149

(22) Filed: Mar. 21, 2001

(30) Foreign Application Priority Data
Mar. 23, 2000 (DE) 100 14 314.8

(51) Int. Cl. B23G 5/00

(52) U.S. Cl. 408/199

(57) ABSTRACT

A method and a device for hand-operated machine tools, particularly for hammer drills, for optimal cutting of different substrates by energy adaptation, wherein the machine tool, when turned on, is operated initially—preferably in a pre-selectable manner—in a first operating state (I) with reduced power consumption at reduced nominal voltage (e.g., 170 V). After a predetermined time period of 5 seconds, for example, a second operating state (II) with increased power consumption at full nominal voltage of, for example, 230 V, is switched to automatically. In the first operating state with reduced power consumption, the single-blow energy is reduced and/or the hammer rate and rotational speed are decreased. In particular, such a method and device ensures that cutting is carried out without damage in the case of hollow block material and a precise tap-drilling is ensured in the case of solid material. In the second operating state with increased power consumption, the single-blow energy and the frequency and rotational speed are adjusted to an increased desired value ensuring fast setting of a bore hole.

### FIELD OF THE INVENTION

The invention is directed to a method and device for hand-operated machine tools for optimized cutting of different substrates. In particular, the invention is directed to a method for automatically presetting a hand-operated machine tool, particularly a hammer drill, which can be operated in different operating states, wherein the machine is initially switched to a first operating state with reduced power consumption when turned on and, after a short predetermined time, is switched to a second operating state with increased power consumption. Moreover, the invention is directed to a hand-operated machine tool, particularly hammer drill, wherein the device automatically adjusts to a first operating state with reduced power consumption when the machine is turned on and switches over in a time-dependent manner to a second operating state with increased power consumption

### BACKGROUND DESCRIPTION

Machine tools of the type mentioned above, that is, hammer drills in particular, are used to cut a wide variety of substrates. In a simple embodiment, these devices, after being turned on, are generally operated in one individual operating mode with constant pre-settable power consumption. In addition, such devices can be outfitted with an adjusting element, e.g., a potentiometer, which is generally integrated in the handle, so that the user can adapt the device for cutting different substrates by changing the rotational speed and/or the hammer rate and single-hammer-blow energy.

Before cutting, however, it is often impossible to see from the outside what type of material the substrate to be cut is made of. With excessive rotational speeds or excessive single-blow energy, the problem arises, particularly in certain materials such as hollow blocks, as they are called, that the energy provided is too high and can result in unwanted damage to the substrate, for example, by collapsing intermediate webs, so that holding elements such as dowels can no longer be anchored with sufficient strength. This applies particularly to hammer drills outfitted with the adjusting members mentioned above, for example when the user mistakenly sets an excessively high motor speed when switching on the device.

EP 0 734 116 A2 describes a method and a circuit arrangement for operation of an electric motor in an electric hand tool. In a first operating phase, the motor can be operated at a first, variably pre-adjustable speed until a preset limiting torque is reached. In a subsequent operating phase, the motor is operated through torque pauses to a periodically interrupted final torque or after-torque. Better work results are achieved in this way, especially when screwing in screws.

### SUMMARY OF THE INVENTION

It is the object of the invention to improve a machine tool of the type mentioned above such that with different, initially unknown materials to be cut, an optimal holding coefficient is always achieved in the substrate without risk of mishandling of the device resulting in an unavoidable worsening of the holding coefficients.

In accordance with the invention, there is provided a method for automatically presetting a hand-operated machine tool, especially a hammer drill, which can be operated in different operating states, wherein the machine is initially switched to a first operating state with reduced power consumption when turned on and, after a short predetermined time period, is switched to a second operating state with increased power consumption.

The method according to the invention can be applied particularly in a hand-operated hammer drill by which, for example, fastener bore holes et al. are to be set in a hollow block material or solid material. When the machine is turned on, the supplied supply voltage or line voltage of, e.g., 230 V nominal value is reduced to an appreciably lower value, e.g., 140 to 200 V, particularly 170 V, by means of, e.g., a thyristor element triggered by a timing logical element. The hammer drill is accordingly operated in this first operating state with low single-blow energy and/or lower hammer rate and/or lower rotational speed. In particular, the collapsing of intermediate webs in hollow block materials can be avoided in this way, so that a substantially better holding coefficient is achieved, on the whole, for dowels or other fastening elements.

According to the invention, the hammer drill is initially operated for a determined period of, e.g., 5 seconds in a first operating state, wherein a setting depth of several times 10 mm, for example, 80 mm, is achieved during this first operating phase, for instance when cutting hollow block bricks, so that a sufficient guiding of the drill is ensured. In an advantageous constructional variant, the first time period for the first operating state is variably adjustable. However, for most applications, a fixed preset time period is desirable; accordingly, a presetting to 2 to 20 second, particularly 5 seconds, is to be provided, for example. The subsequent automatic upshifting to high single-blow energy ensures a desired quick setting of a hole intended for holding elements. The guiding of the drill, which is now reliable, prevents unwanted bursting of intermediate webs in the hollow block material.

It is advantageous to switch the hammer drill initially and compulsorily into the first operating state every time it is turned on. This prevents the user from operating the hammer drill incorrectly and with full power consumption immediately. A possibly unintentional altering of the operating performance of the hammer drill is reliably prevented.

After the predetermined time period has elapsed, the reduction of the nominal voltage is suspended; the machine switches automatically until the nominal voltage is switched down, for example, to a line voltage of 230 V. At increased power consumption in the second operating state, the device is then operated at a predetermined higher rotational speed and/or at a higher hammer rate or higher single-blow energy.

With the method according to the invention, advantages are also gained in cutting solid material because a precise tap-drilling of the material is ensured during the first operating state and the drill is prevented from accidentally sliding off the location to be drilled.

A hand-operated machine tool, especially a hammer drill, is characterized according to the invention by a device for automatically adjusting a first operating state with reduced power consumption when the machine is turned on and for switching over in a time-dependent manner to a second operating state with increased power consumption. Switching over from the first operating state to the second operating state is effected compulsorily and without the direct influence of the user of the device.

In a particularly advantageous manner, the timer circuit which is provided for time-dependent switching over and which has a power switching element, for example, a thyristor, as an integrated circuit or as a hybrid circuit is integrated directly in the handle or in a push switch in the handle of the machine.

Other advantageous constructions and further developments of the inventive idea are explained more fully in the following description.

### BRIEF DESCRIPTION OF THE DRAWINGS

The invention and advantageous details thereof are described more fully in the following description with reference to the following drawings by way of example.

FIG. 1 shows a block diagram illustrating a method in accordance with the invention;

FIG. 2 shows a time graph illustrating different operating states;

FIG. 3 shows a schematic sectional view of a commercially available hammer drill which is outfitted with a switchover device according to the invention;

FIG. 4 shows a schematic perspective view of a hand switch which is actuated by finger pressure and is swivelably articulated in the handle of a machine tool and has a selector lever for different press-in depths for selective operation preset; and

FIG. 5, with parts 5a, 5b and 5c, shows a schematic top view of the hand switch with associated selector lever of FIG. 4 illustrating its operation.

### DETAILED DESCRIPTION OF THE INVENTION

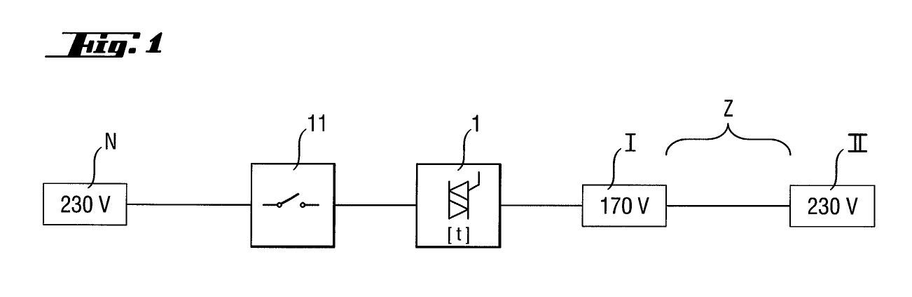

FIG. 1 illustrates the basic sequence of the method according to the invention. A nominal voltage, for example, a line voltage of 230 V, is supplied to the machine via a line cord N, referred to in FIG. 3. A device 1, according to the invention, for initial, brief reduction of the nominal voltage of 230 V to, e.g., 170 V is contained in the handle of the machine with an ON/OFF hand switch 11.

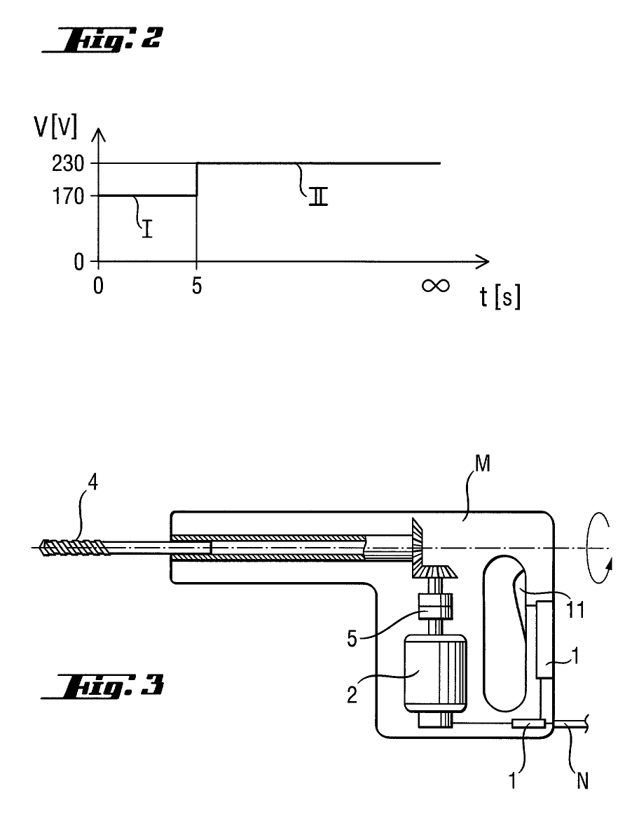

As is seen from FIG. 1, the motor 2 of the hammer drill M, of FIG. 3, is initially provided with the reduced voltage of, e.g., 170 V after being turned on by actuating the ON/OFF hand switch 11, so that a first operating state 1, shown in FIG. 2, with reduced power consumption is preset and adjusted. The reduction of the supply voltage is advantageously carried out by means of a controllable power semiconductor switch, particularly a thyristor, which is driven by an electronic timer. At the reduced voltage of 170 V in the first operating state, the hammer drill M is accordingly operated in particular with low single-blow energy at low speed and low hammer rate.

After a predetermined time period of several seconds, for example, 2 to 20 seconds, preferably 5 seconds, the device 1 for the time preset and switchover causes an upshifting to the normal rated voltage of, e.g., 230 V. The reduction in the nominal voltage to 170 V, which is adjusted initially when turning on, is canceled and the machine M is switched over to the second operating state II, shown in FIG. 2, with increased power consumption. The hammer drill M now operates with a greater single-blow energy, higher rotational speed and/or increased hammer rate.

The processes described above are illustrated in a time chart shown in FIG. 2. In a first operating state I, that is, when the hand switch 11 is actuated, the supply voltage V is initially switched to a reduced nominal value of, e.g., 170 V. After a predetermined time period Z of 5 seconds, for example, this reduced supply voltage is canceled and the second operating state II is switched to, that is, in general, a switching over to a line voltage of 230 V is effected. In FIG. 2, a voltage changeover is provided after a time period of 5 seconds for the first operating state I in the form of a step function. The hammer drill M is accordingly switched over immediately to the nominal voltage, particularly the line voltage of 230 V, when a period of 5 seconds has been exceeded. A continuous switching over with a continuous transition from the first operating state to the second operating state can likewise be provided, wherein the transition time is advantageously pre-adjusted to several seconds, for example, 2 to 4 seconds. As can also be seen from the horizontal curve shape in FIG. 2, the level of applied supply voltage is constant during the first operating state I and during the second operating state II. It can also be seen from the curve shape in FIG. 2 that the hammer drill M remains “infinitely long” in the second operating state II with continued actuation of the hand switch 11. The machine M is turned off only when the hand switch 11 has been released. When the hand switch 11 is actuated again, the reduced supply voltage of 170 V is again supplied initially. Accordingly, without some other kind of possible switchover, it is impossible for the user of the device to switch on the second operating state II immediately and directly by actuating the hand switch 11.

The hammer drill M, which is shown in FIG. 3, has a hammering mechanism (not shown) which propels the drill 4 in translational motion and which is driven by the motor via a safety clutch 5 which is not relevant in the connection with the invention. As is shown, the switchover device 1 according to the invention can be fitted directly in the handle or integrated therein.

By means of the invention, a commercially available hammer drill can be modified—also retrofitted—in such a way that cutting can be adapted to different substrate materials in every case. In the first operating state I with reduced power consumption which is adjusted automatically after turning on, a sufficiently deep setting hole is achieved on the one hand in relatively unstable hollow block materials so as to ensure good guiding of the drill 4. Damage to the material, especially bursting of intermediate webs, is prevented. On the other hand, in the case of solid material, a hole to be set is pilot-drilled initially so that the drill 4 is reliably prevented from sliding off. A fast setting of the desired fastener hole is simultaneously ensured by switching to operating state II which is carried out after, e.g., 5 seconds.

According to an advantageous development of the invention, the machine tool can have a selection device by which a preset can be selected for the automatic adjustment of the first and, subsequently, the second operating state. In one setting of the selection device, the two-stage upshifting of the machine according to the invention is adjusted, while in the other setting of the selection device, the operating parameters desired by the user of the device, that is, the second operating state with increased power consumption, are immediately available.

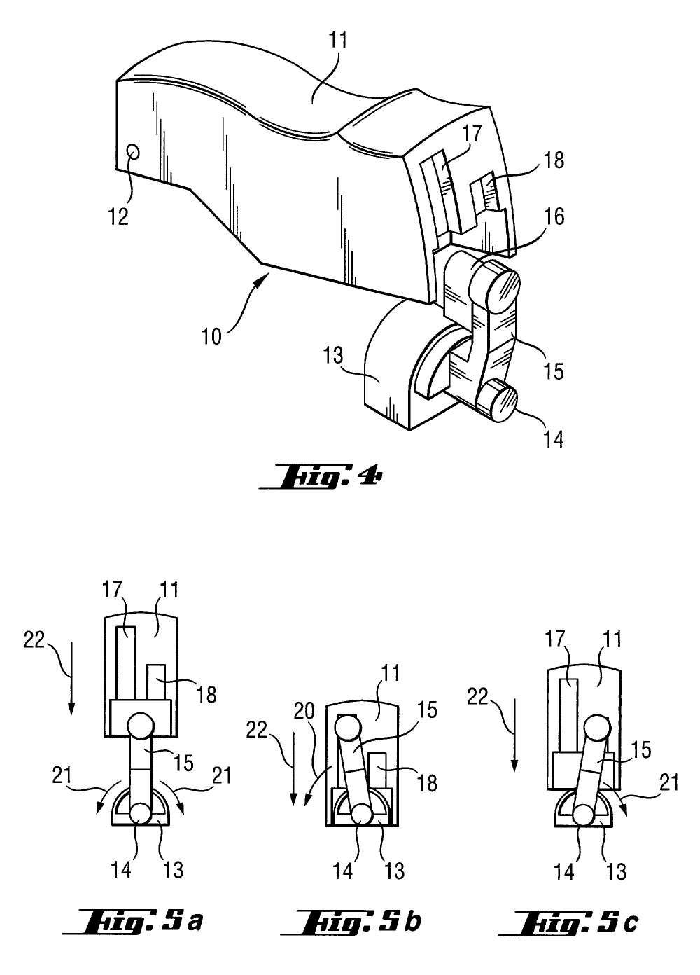

FIGS. 4 and 5 show an embodiment for a selection device which contains a purely mechanical solution in the illustrated example. Of course, appropriate purely electrical or electromechanical selection devices are also possible and would require no special explanation for the person skilled in the art.

FIG. 4 shows a view in perspective of the selection device which is designated generally by 10 and which comprises the combined action of an ON/OFF hand switch 11 articulated at a swivel pin 12 in the handle-side housing part of the machine M and a swivel lever 15 which is likewise mounted in the handle-side housing part of the machine M in a bearing block 13 and which is swivelable about a pivot pin 14. Two catch grooves 17 and 18 having different depths are formed on the upper side, facing the observer, of the spring-biased hand switch 11 which is articulated at 12, wherein a guide shoe or sliding block 16 provided at the swivel lever 15 is oriented toward the catch grooves 17 and 18 depending on the selected swiveling position of the swivel lever 15. As can be seen from the individual positions shown in FIGS. 5a to 5c, the swivel lever 15 and its associated sliding block 16 are swivelable inside a cutout 19 in the hand switch 11 between two stop positions in a first swiveling direction 20 and second swiveling direction 21. However, this movement is only possible provided that the spring-biased hand switch 11 is not pressed by the user of the device, that is, as long as it is not locked into the grooves. This hand switch position is illustrated in FIG. 4 and in FIG. 5a. The swivel lever 15 is swivelable between the two catch grooves 17 and 18 with different depths. When the swivel lever 15 is swiveled into the position illustrated, in FIG. 5a, by arrow 20, the hand switch 11 can be pressed in farther in the direction of arrow 22 (compare FIG. 5b) than in the other swivel position with orientation toward the shallower catch groove 18 (compare FIG. 5c).

When the selector lever 15 is in the left-hand position, that is, in the position oriented to the deep catch groove 17, as shown in FIG. 5b, the user of the device can fully depress the ON/OFF hand switch 11 and the preadjusted operating parameters of the machine tool M corresponding to the second operating state can immediately take effect. Such positioning can be important for many applications, particularly with the possibility of selecting chisel operation. On the other hand, in the swivel position of the selector lever 15, shown in FIG. 5c, the ON/OFF hand switch 11 cannot be pressed in completely. The positioning shown in FIG. 5 illustrates the selected automatic adjustment, according to the invention, of the operating performance of the machine M in which the first operating state I with reduced power consumption is automatically adjusted initially and subsequently, in time-dependent manner, the second operating state II with increased power consumption is switched to.

What is claimed is:

1. A method for automatically presetting a hand-operated machine tool (M), particularly a hammer drill, that can be operated in different operating states, wherein the machine (M) is initially switched to a first operating state (I) with reduced power consumption when turned on and, after a short predetermined time, is switched to a second operating state (II) with increased power consumption.

2. The method of claim 1, wherein the machine (M) is switched from the first operating state (I) to the second operating state (II) after a time period of 2 to 20 seconds.

3. The method of claim 2, wherein the time period is approximately 5 seconds.

4. The method of claim 1, wherein the machine (M) is supplied with a voltage of 140 to 200 V, particularly 170 V, in the first operating state (I).

5. The method of claim 4, wherein the machine (M) is operated in the first operating state (I) with at least one of reduced rotational speed, reduced hammer rate, and reduced single-blow energy in comparison with the second operating state (II).

6. The method of claim 1, wherein the machine (M) is supplied with a nominal voltage between 210V to 240 V, in the second operating state (II).

7. The method of claim 6, wherein the machine (M) is operated in the second operating state (II) corresponding to the increased supply voltage at at least one a higher rotational speed, higher hammer rate, and substantially increased single-blow energy.

8. The method of claim 1, wherein the automatic preadjustment can be inhibited.

9. A hand-operated machine tool (M), particularly hammer drill, comprising a device for automatically adjusting a first operating state (I) with reduced power consumption when the machine is turned on and for switching over in a time-dependent manner to a second operating state (II) with increased power consumption.

10. The machine tool of claim 9, comprisng a device that compulsorily blocks the second operating state (II) for a predetermined period of several seconds when the machine is turned on.

11. The machine tool of claim 9, comprising a timer circuit which can be initialized by an ON/OFF hand switch (11) and which sets a thyristor to reduced output voltage during the first operating state (1) and, after a predetermined time period of several seconds, causes the nominal voltage to be switched through to the motor of the machine.

12. The machine tool of claim 9, wherein the automatically adjusting device is installed in an ON/OFF switch of the machine (M).

13. The machine tool of claim 9, comprising a selection device at the machine (M) for presetting the automatic adjustment.

14. The machine tool according to claim 13, wherein the selection device is a mechanical selection device associated with an ON/OFF hand switch of the machine (M).

15. The machine tool of claim 14, wherein the selection device is a selector lever that can be swiveled between two catch positions defined in the housing of the ON/OFF hand switch (11) by grooves of different lengths.

16. The method of claim 1, wherein the machine (M) is supplied with a line voltage of 230 V, in the second operating state (II).
